(19) United States
(12) Patent Application Publication
(10) Pub. No.: US 2007/0294117 A1
(43) Pub. Date: Dec. 20, 2007

(54) Airline seat mile fare index market system and method

(76) Inventors: Denver W. Lopp, Brooke, IN (US); Mike Suckow, West Lafayette, IN (US); Melinda McKay, Milford, IL (US); Ron Utecht, Grass Valley, CA (US); Robert Harrell, New York, NY (US)

Correspondence Address: BOSE MCKINNEY & EVANS LLP;JAMES COLES, 135 N PENNSYLVANIA ST, SUITE 2700, INDIANAPOLIS, IN, 46204, US

(21) Appl. No.: 11/757,092

(22) Filed: Jun. 1, 2007

Related U.S. Application Data
(60) Provisional application No. 60/810,618, filed on Jun. 2, 2006.

(51) Int. Cl. G06Q 10/00

(52) U.S. Cl. 705/5

(57) ABSTRACT

A system and method of computing an airline market index and an airline market index trading system. Embodiments of the airline market index being computed by selecting a set of airline routes and estimating a distance and fare for each airline route. An average seat mile fare for each airline route can be calculated, and then these values combined to calculate a multi-route average seat mile fare, from which the airline market index can be calculated. The airline market index can include airline market index contracts having prices and delivery dates as well as options contracts.

### RELATED APPLICATIONS

This application claims the benefit of U.S. Provisional Application Ser. No. 60/810,618, filed on Jun. 2, 2006, entitled “Airline Seat Mile Fare Index Market System and Method,” which is incorporated herein by reference.

### BACKGROUND AND SUMMARY

This invention relates generally to market trading systems, and more particularly to market trading systems regarding the airline industry.

It was estimated at the World Air Transport Summit held May 2005 in Tokyo that the airline industry represents approximately 4.5% of the global GNP. The cyclical airline business and the large volume of money spent in this economic segment creates a base for high volatility and volume in a market for airline seats per unit distance, such as an Airline Seat Mile Fare Index (ASMFI) market. World events, fuel prices, the general economy, and various other factors create wide variations in the values of airline seats in both short and long term pricing periods. By enabling speculators and other traders to participate in an airline seat futures and options market and establishing a clearing house for the market, such a market could provide a tool for airlines to distribute and control their risk. As in other futures and options markets, speculators and other traders would provide a form of risk management for the airline business, which could help reduce the need for governmental intervention in stabilizing transportation businesses.

The ASMFI could be constructed similar to other commodity trading markets, such as in the agriculture or energy exchanges. The ASMFI commodity could provide hedging opportunities for both providers and users, along with stimulating a speculation base of trading due to the large economic impact of the airline industry in relation to the GNP. The daily level of media attention given to the airline transportation industry and their economic situations could also help to encourage trading in such a market.

Additional features and advantages of the invention will become apparent to those skilled in the art upon consideration of the following detailed description of illustrated embodiments.

### BRIEF DESCRIPTION OF THE FIGURES

Aspects of the exemplary embodiments are more particularly described below with reference to the following figures:

FIG. 1 is a high-level diagram of an exemplary method for computing an Airline Seat Mile Fare Index;

FIG. 2 is a high-level diagram of an exemplary structure for a clearing house to administrate the purchase of buy and sell contracts;

FIG. 3 illustrates some of the trading opportunities available in an exemplary embodiment of the ASMFI market;

FIG. 4 shows some of the trading strategies that could be used in an exemplary embodiment of the ASMFI market; and

FIG. 5 shows some of the entities that would potentially participate in an embodiment of the ASMFI market.

### DETAILED DESCRIPTION OF EXEMPLARY EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. To ease explanation and minimize confusion, throughout the following description the exemplary embodiments will be described in terms of miles and dollars. It should be understood that other distance units, such as kilometers, etc., could be used in place of miles and other monetary units, such as Euros, Yen, British Pounds, etc. could be used in place of dollars.

An embodiment of an Airline Seat Mile Fare Index (ASMFI) can be based on published airline fares for a representative sample size of selected airline routes. In one embodiment, the index can be based on economy class published fares, and the airline routes used in the index can be some combination of most traveled airline routes. The model can use published fares for some predetermined set of conditions, such as for example economy class fares with a certain advance purchase limitation and a planned minimum stay of a designated period. As an example, the model could use published economy class fares for a two week (14 day) advance purchase ticket on each route, with a planned minimum stay of a one week period. Of course, different parameters can be used for the index, or the index could be based on some combination of different parameters. The published fares used in the model can be averaged and divided by the representative route flight miles to arrive at a seat cost per mile value. The actual index value can be calculated as an average of published fares in seat cents/mile for a certain contract size. The index can be constructed to present a sufficient sample size that would represent a close approximation of actual seat cents/miles revenue, while providing protection against index price manipulation. For example, the index could be composed of ten, thirty or some other number of routes for various airlines.

Future and option markets can be designated for each twelve months. The availability and constant volume of airline miles for each month can support monthly trading contracts. Contract closing or delivery dates can be set to be in line with typical contract trading guidelines. Embodiments of the ASMFI markets and contracts can be constructed to comply with existing and standard regulated trading rules for futures and options markets.

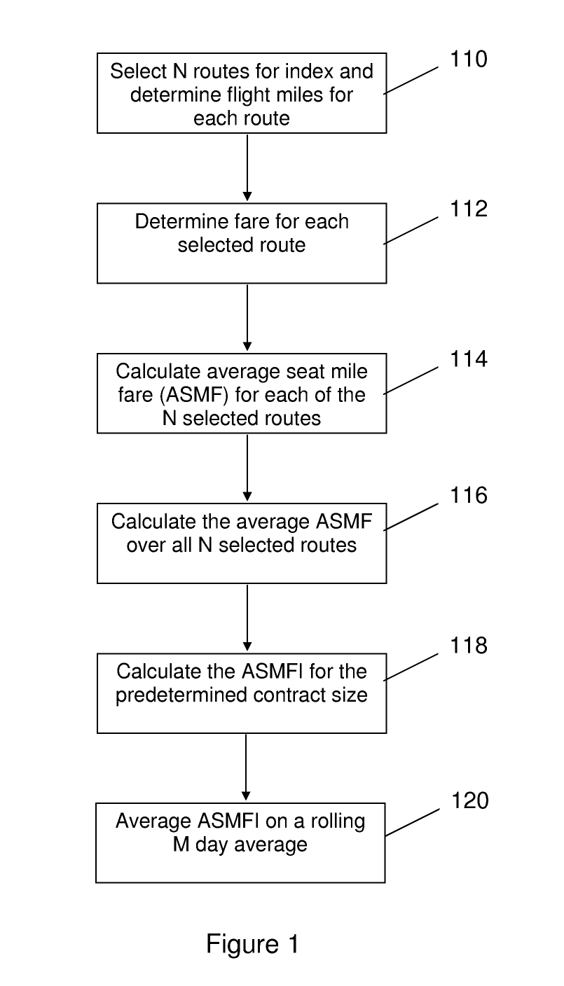

FIG. 1 shows an exemplary embodiment of a method for computing the ASMFI value and will be discussed with the following example data. The following example is provided for explanatory purposes and not for limitation, it being appreciated that the number of routes and various other parameters of the example can be changed as desired.

At step 110, the N routes to be used in the index are selected and the flight miles for each route are determined. The top five U.S. domestic routes for March 2005 to February 2006 according to the U.S. Department of Transportation and the flight miles for each route are shown in the following table. These five routes will be used for this exemplary embodiment of the

ASMFI.

| | Route | Miles |
|---|---|---|
| 1 | Orlando, FL (MCO)-Atlanta, GA (ATL) | 399 |
| 2 | Las Vegas, NV (LAS)-Los Angles, CA (LAX) | 233 |
| 3 | New York, NY (LGA)-Chicago, IL (ORD) | 722 |
| 4 | Los Angles, CA (LAX)-Chicago, IL (ORD) | 1,718 |
| 5 | New York, NY (LGA)-Atlanta, GA (ATL) | 751 |

At step 112, the fares for each of the N routes selected in step 110 are determined. The fares can be based on a certain set of conditions, such as the average published economy class fares for a future fourteen day advance purchase with a planned minimum stay of one-week. These fare values can fluctuate during the day depending on various factors affecting airlines and airline fares. A daily closing value for these fares can be determined by establishing a market close time, and setting the closing value for the fares on each of the selected routes to the fare price on that day at the market close time. The average lowest published economy class fares for the five routes of this example are shown below for May 21, 2005 and May 9, 2006.

| | | Average fare | Average fare |
|---|---|---|---|
| | Route | May 21, 2005 | May 9, 2006 |
| 1 | MCO-ATL | $155 | $152 |
| 2 | LAS-LAX | $94 | $62 |
| 3 | LGA-ORD | $179 | $112 |
| 4 | LAX-ORD | $158 | $198 |
| 5 | LGA-ATL | $220 | $135 |

At step 114, the average seat mile fare (ASMF) for each of the N selected routes is computed by dividing the fare for the route by the flight miles for the route. For this example, the ASMF for each route is computed as follows:

$$ASMF ( cents / miles ) = \frac{( \begin{matrix}average economy class published fares \\ for the route\end{matrix} )}{( average miles for the route )}$$

and the ASMF values for the five selected routes on May 21, 2005 and May 9, 2006 are:

| | | ASMF | ASMF |
|---|---|---|---|
| | Route | May 21, 2005 | May 9, 2006 |
| 1 | MCO-ATL | 0.3885 | 0.3809 |
| 2 | LAS-LAX | 0.4034 | 0.2661 |
| 3 | LGA-ORD | 0.2479 | 0.1551 |
| 4 | LAX-ORD | 0.0920 | 0.1152 |
| 5 | LGA-ATL | 0.2929 | 0.1798 |

At step 116, the average ASMF for the N selected routes is computed by adding together the ASMF values for the N routes and dividing by N, the number of routes. For the five routes of this example, the average ASMF for May 21, 2005 and May 9, 2006 are:

| | |
|---|---|
| Average ASMF for May 21, 2005 | 0.2849 |
| Average ASMF for May 9, 2006 | 0.2194 |

At step 118, the ASMFI is computed by multiplying the average ASMF (cents/mile) over the N selected routes by the contract size of an ASMFI contract. For this embodiment, the contract size would be in number of flight miles. For the example we will use a contract size of 250,000 flight miles which results in the following values of the ASMFI for May 21, 2005 and May 9, 2006:

| | |
|---|---|
| ASMFI for May 21, 2005 | $71,225 |
| ASMFI for May 9, 2006 | $54,850 |

At step 120, the average ASMFI is computed for a rolling M day average. After the new day's ASMFI value is calculated at step 118, the M day rolling ASMFI average can be calculated as follows: (0) keep a total of the ASMFI values for the last M days and the individual ASMFI values for the last M days; (1) add the new day's ASMFI value calculated at step 118 to the total of the ASMFI values for the last M days; (2) subtract the ASMFI value of M days ago from the total of the ASMFI values for the last M days; and (3) divide the newly computed total of the ASMFI values by M.

For this exemplary data, the ASMFI value varies over this approximately one year period by $16,375. This demonstrates the large market movement that can occur during an expected life of an ASMFI contract. Future or option market users would have the opportunity to participate in the large movement of airline fares by either speculating or hedging through trading in the ASMFI market.

Another exemplary embodiment of a method for computing the ASMFI value is described below. First, find routes for active domestic air carriers and select the largest city pair route volumes to be the city pairs for the index. For example, the top 100 or top 300 city pair route volumes for active domestic air carriers. Determine the roundtrip distance for each city pair selected for the index.

After the city pairs for the index are selected, obtain the most current month of historical data that reflects actual airline results for airline seat mile returns for each city pair. From the historical data, determine the fare mix that reflects the actual makeup of non-first-class fares for each of the selected city pair routes. For example, for a city pair where the non-first-class fares include full coach fares, leisure fares, full business fares, alternate business fares, etc., the system could estimate the actual fare mix as a percentage makeup of each of these fare classes for that city-pair.

In this embodiment, an index fare formula of the following form can be used:

$$IF = {\sum }_{farelvl} ( \# seats ) * ( \% {seats}_{lvl} ) * ( {fare}_{lvl} )$$

where (#seats) is the number of available non-first-class seats on both the outbound and inbound legs of the city pair flight, (% seatsₗᵥₗ) is the percentage of seats available at each particular fare level, (fareₗᵥₗ) is the fare amount at each particular fare level. The actual historical data can be used to update the (% seatsₗᵥₗ) value in the index fare formula.

One way to determine the (fareₗᵥₗ) values for the round trip flight between each of the selected city pairs of the index is to data mine the published fares at the various fare levels for the city pair at K random times during the day, and randomly select the departure city for the round trip fare for the city pair flight. The fare amount for each of the various fare levels for the round trip flight between each of the selected city pairs of the index can then be computed from the K samples for that day as the mean, median or some other representative value.

Using an estimate of the number of available non-first-class seats, (#seats), for each published roundtrip flight between each of the selected city pairs, the total per flight fare revenue can be computed using the index fare formula. A total fare revenue for each city pair can then be computed by summing the per flight fare revenue for all roundtrip flights for the city pair. A total estimate of available non-first-class seats, including the seats on both the outbound leg and the inbound leg, can also be computed for the selected city pair. Dividing the total fare revenue for each city pair by the total number of available non-first-class seats for the city pair provides an estimate of the revenue per seat for the city pair. Dividing the revenue per seat for the city pair by the round trip distance for the city pair provides the ASMF for the city pair, for example in units of cents/seat-mile.

The ASMF for each of the city pairs can now be combined to obtain the overall ASMF. One way of combining the city pair values is by using weighting scheme described below based on the miles flown for each city pair. The total miles flown for each city pair can be calculated by multiplying the number of roundtrip flights for the city pair by the estimated roundtrip mileage for the city pair. The total per seat revenue for each city pair can then be estimated by multiplying the ASMF for the city pair by the total miles flown for the city pair. The total per seat revenue for all of the city pairs can be estimated by summing the per seat revenue for each of the city pairs. The total miles flown for all of the city pairs can also be estimated by summing the total miles flown for each of the city pairs. The overall ASMFI can then be calculated by dividing the total per seat revenue for all of the city pairs by the total miles flown for all of the city pairs.

The ASMFI contract value (dollars) is computed by multiplying the overall ASMF by the desired contract size (seat-miles). The average ASMFI over a rolling M day period can then be computed.

An average ASMFI can also be computed for a rolling M day average. After the new day's ASMFI value is calculated, the M day rolling average ASMFI can be calculated using a queue of the individual ASMFI values for the last M days. The ASMFI value for the new day is added to the front of the queue and the ASMFI value of M days ago drops off the back of the queue. The M day rolling average ASMFI value can be computed by totaling the ASMFI values for the last M days and dividing the total of the ASMFI values by M.

The structure of the ASMFI market in the embodiments described above could be operated under the Commodity Exchange Act, Exempt Boards of Trade (XBOTs), Section 5d of the CE Act and Part 36.2 of CFTC's regulations. Commodities eligible to trade as Exempt Boards of Trade are those that are based upon: (1) a nearly inexhaustible deliverable supply; (2) a sufficiently large deliverable supply and a sufficiently liquid cash market to render any contract traded on the commodity highly unlikely to be susceptible to the threat of manipulation; or (3) no cash market. The above embodiment of the ASMFI would satisfy the above criteria since there is a nearly inexhaustible supply of airline seat miles, and the sample size of airfare city pairs could be made large enough to limit manipulation by airlines, speculators, or other parties.

The ASMFI can be treated as an index with no delivery against an actual cash market. The dollar amount of gains or losses on ASMFI futures or options could be applied to actual airline ticket fares by buying or selling actual tickets using available methods such as direct airline sales, internet sale companies, travel agents, etc. This reduces the complications of gaining acceptance from airlines to participate in a future airline miles conversion program or future delivery programs. Airlines or other users would have the choice to use the future or option contracts for future protection or speculation as market values change with economic variables.

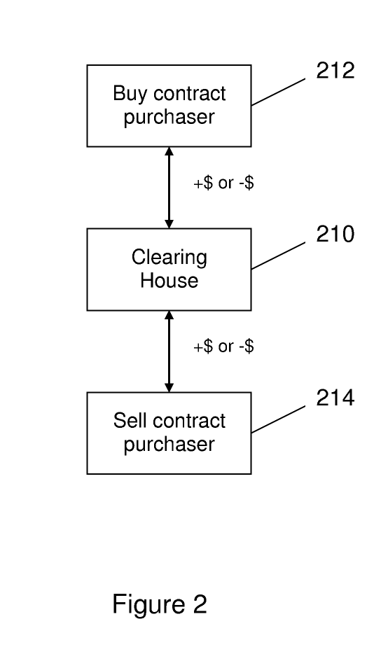

A registered clearing organization can administrate the open contracts through delivery dates as shown in FIG. 2. The clearing house 210 can match a buy contract purchaser 212 with a sell contract purchaser 214. The purchase price for the buy contract and the sell contract are set by the ASMFI market at the time of the trade.

Contract owners that hold a “buy” contract through the contract's delivery date could be obligated to purchase the ASMFI contract at its closing contract price on the delivery date. The difference between the purchase price of the buy contract and the closing market value of the ASMFI on the delivery date would determine the gain or loss of the contract owner. The buy contract owner could receive the gain if the ASMFI went up, or pay the loss if the ASMFI went down, over the period between the buyer's purchase of the ASMFI buy contract and the ASMFI close on the delivery date.

Contract owners that hold a “sell” contract through the contract's delivery date could be obligated to sell the ASMFI contract at its closing contract price on the delivery date. The difference between the purchase price of the sell contract and the closing market value of the ASMFI on the delivery date would determine the gain or loss of the contract owner. The sell contract owner could receive the gain if the ASMFI went down, or pay the loss if the ASMFI went up, over the period between the seller's purchase of the ASMFI sell contract and the ASMFI close on the delivery date.

The ASMFI could be constructed similar to other commodity trading markets, such as in the agriculture or energy exchanges. The ASMFI commodity could provide hedging opportunities for both providers and users, along with stimulating a speculation base of trading due to the large economic impact of the airline industry. The future and option trading contracts could be structured over twelve trading months and setup in an Airline Seat Mile Fare Index (ASMFI) format like the embodiment described above.

The index contract could be sized at 250,000 seat miles, which approximately represents the volume equivalent of a Boeing 757 aircraft with 180 economy seats flying about 1,400 miles. As an example, at $0.15 to $0.20 per seat mile this contract size would represent a total value of $37,500 to $50,000 comparable revenue. Variable margin requirements could be fashioned after similar volatile and like size commodity contracts. In order to increase usage of the contracts for small or medium traders or speculators, development of mini contracts could also be explored for exchange trading. As an example, at $0.20 per mile, mini-contracts sized at 5,000 seat miles, 25,000 seat miles and 50,000 seat miles would have values of $1,000; $5,000; and $10,000, respectively.

Airline seat miles can be treated as perishable commodities, in that a set of seat miles are produced per flight and become non-transferable once that flight has departed. This type of perishable commodity produces a high level of market fluctuation, as providers attempt to fill unfilled seats on aircraft to achieve near 100% load factor levels. An aircraft at a low load factor costs essentially the same to operate as an aircraft at a very high load level. The unfilled seats approaching departure time become a volatile and perishable commodity providing a highly competitive and changing market value.

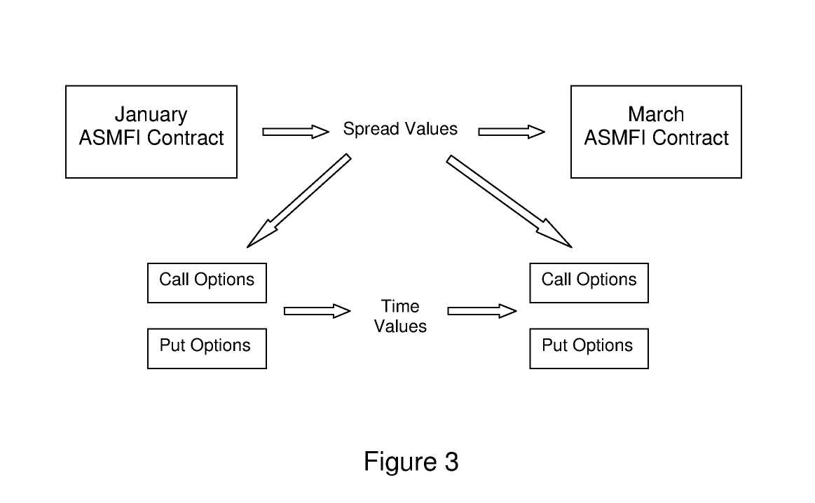

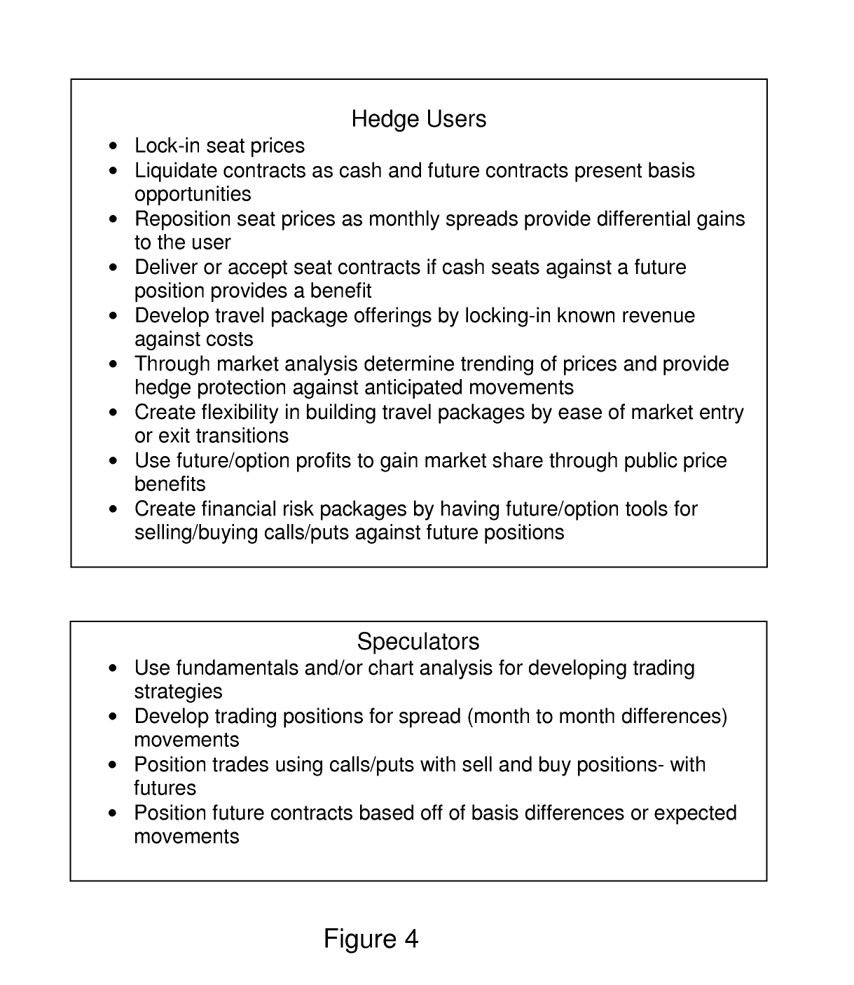

FIG. 3 illustrates some of the trading opportunities available in an exemplary embodiment of the ASMFI market. The difference between the price of a January ASMFI contract and a March ASMFI contract creates a spread value. Spread values and volatility could be traded. Call options and put options having option expiration dates create a time value as option life slowly expires. Combinations of buying and selling ASMFI contracts and options on ASMFI contracts could enable very complicated strategies to be generated for either market hedgers or speculators. FIG. 4 illustrates some of the market strategies that could be developed as used in other commodity future/options contracts.

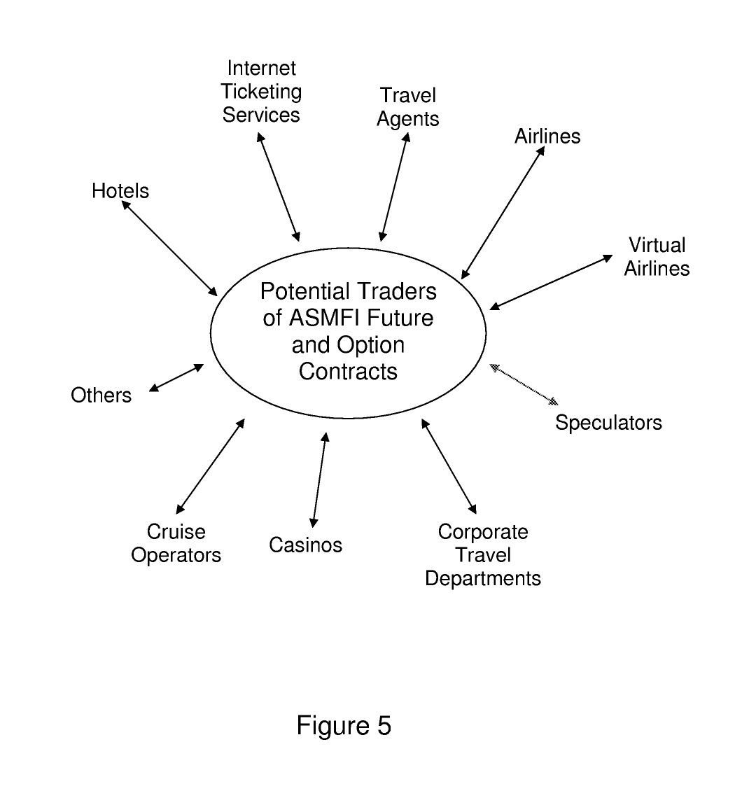

FIG. 5 shows some of the many potential types of ASMFI traders that would purchase ASMFI futures and options contracts for various reasons in different embodiments. Airlines could use the ASMFI contracts and options to hedge future revenue, allowing them to transfer a large portion of the risk to the speculator market user. Option positions would allow creative measures to be taken by the airlines, allowing protection and upside potential in moving markets. ASMFI contracts by an airline could be converted to cash value against actual seats sold by closing out contracts in the futures markets, either by direct buy-sell of ASMFI contracts or execution of option market positions. However, it would be estimated, as in other commodity listings, that very few contracts would be carried through the delivery date allowing airlines to buy and sell contracts as economic decision factors affect the market place. With airlines having the ability to hedge future revenue against fuel costs and other known fixed costs, the ASMFI market could provide the airlines with the opportunity of building solid business plans with a increased degree of stability in revenues and costs.

Travel agencies and internet ticketing services could also be large users of ASMFI contracts and options. With the ability to lock-in simulated future seat mile prices, travel agents could create package travel programs at known costs with flexible options when choosing actual airline bookings. Using ASMFI options and future contracts, travel agencies could guarantee airline-booking costs and have the ability to reduce prices or increase revenue if market situations fluctuate. Monthly future spreads and differences between actual airline seat mile revenue and the ASMFI traded value could create competitive gains for travel agencies participating in the ASMFI market during certain economic time periods. Travel agencies would be able to plan and develop creative market scenarios for their customers, as pricing options could be used for establishing market stability in the future. The ease of entering and exiting the ASMFI market could allow travel agencies to provide long-term travel packages and backfill bookings when cash pricing provided positive opportunities.

Virtual airlines could be developed through the use of ASMFI futures and options as companies could create a market plan for purchasing or selling actual airline seats against future positions. Airline seats would become an actual commodity allowing purchasing and selling to be created in an open and free market system. New internet-structured companies could be developed that buy ASMFI contracts that could be used to establish value for later bookings on an actual airline. These companies could be a derivative of existing internet companies that now act as open agents of airlines or new structured companies providing new creative markets for the public. Competitiveness could be created as companies implement trading strategies to gain advantage in offsetting actual airline ticket prices by applying future gains against airline cash prices. For example, even though an airline may advertise a seat at a $250 fare, a new enterprising company as described above may be able to sell those seats at $225 by applying profits from ASMFI future contracts to reduce the seat fare. This would allow the company to gain a competitive advantage and to gain market share through price sensitivity. Of course, this would depend on the company's ability to create a positive hedging program that creates opportunities when presented with market fluctuations.

Hotels, casinos, and companies that conduct a high amount of travel business could also use the ASMFI future/options contracts to lock-in future travel expenses. Companies that conduct a high amount of travel business could include cruise operators and corporate travel departments. With the cyclical prices of airline seat miles, companies could use the ASMFI market to help stabilize flight costs when developing package travel plans, or use the ASMFI market for pricing protection in future business travel.

The cyclical airline business and the large volume of money spent in this economic segment creates a base for high volatility and volume in the ASMFI market. World events, fuel prices, the general economy, etc. would create wide variations in future ASMFI values in both short and long term pricing periods. With speculators gaining a large portion of the ASMFI future/option market volumes and establishing a market-clearing house, the ASMFI market would provide a tool for airlines to control their financial risk. As in other future/option markets, speculators would provide a form of risk management for the airline business, which could help reduce the need for governmental intervention in stabilizing transportation businesses.

While specific embodiments have been described in detail in the foregoing detailed description and illustrated in the accompanying drawings, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

We claim:

1. A method of computing an airline market index, comprising:
selecting an index route set, the index route set comprising a set of airline routes;
obtaining a route distance for each airline route of the index route set;
estimating a route fare for each airline route of the index route set;
calculating an average seat mile fare for each airline route of the index route set;
calculating a multi-route average seat mile fare over all the airline routes of the index route set;
calculating the airline market index using the multi-route average seat mile fare.

2. The method of claim 1, wherein the step of selecting an index route set comprises:
determining passenger volumes for a plurality of city pairs having airline routes therebetween;
selecting N city pairs of the plurality of city pairs that have the largest passenger volumes, N being selected to protect against price manipulation of the airline market index;
using the airline routes between the N city pairs with the largest passenger volumes as the index route set.

3. The method of claim 2, wherein the step of obtaining a route distance comprises:
obtaining a round trip distance for each city pair airline route of the index route set.

4. The method of claim 2, wherein the step of estimating a route fare comprises the following steps for each city pair airline route of the index route set:
defining a predetermined set of conditions for the route fare;
randomly selecting a departure city for the city pair airline route;
obtaining a published fare for the city pair airline route departing from the departure city under the predetermined set of conditions;
estimating the route fare for the city pair airline route using the published fare.

5. The method of claim 4, wherein the step of estimating the route fare for the city pair airline route further comprises:
defining a market close time for each day;
obtaining a closing published fare for the city pair airline route departing from the departure city under the predetermined set of conditions at the market close time;
estimating a closing value of the route fare for the city pair airline route using the closing published fare.

6. The method of claim 2, wherein the step of estimating a route fare comprises the following steps for each city pair airline route of the index route set:
defining a predetermined set of conditions for the route fare;
defining a market close time for each day;
obtaining a sample published fare for the city pair airline route under the predetermined set of conditions at K random times between the market close time of the previous day and the market close time of the current day;
estimating a closing value of the route fare for the city pair airline route using a representative value computed from the K sample published fares.

7. The method of claim 2, wherein the step of estimating a route fare comprises the following steps for each city pair airline route of the index route set:
estimating a total number of seats available;
estimating a fare mix for the total number of seats available, the fare mix including at least two fare classes;
estimating a class fare for each fare class,
estimating the route fare using the fare mix and the class fare for each fare class.

8. The method of claim 7, wherein the step of estimating a fare mix comprises:
obtaining historical data for the city pair airline route;
calculating actual airline results for airline seat mile returns from the historical data;
determining the fare mix to reflect the actual airline results.

9. The method of claim 7, wherein the step of estimating a class fare comprises the following steps for each fare class:
defining a predetermined set of conditions for the class fare;
obtaining a sample published fare for the class under the predetermined set of conditions at K random times during the day;
estimating the class fare using a representative value computed from the K sample published fares for the class.

10. The method of claim 2, wherein the step of estimating a route fare comprises the following steps for each city pair airline route of the index route set:
obtaining historical data for the city pair airline route;
calculating actual airline results for airline seat mile returns from the historical data;
determining a fare mix using the historical data that reflects the actual airline results, the fare mix including at least two fare classes.
estimating a roundtrip class fare for each fare class for each roundtrip flight between the city pair,
estimating a number of seats available for each roundtrip flight between the city pair;
calculating a flight revenue for each roundtrip flight between the city pair using the fare mix, the roundtrip class fare for each fare class for each roundtrip flight, and the total number of seats available for each roundtrip flight;
calculating a total city pair flight revenue using the flight revenue for each roundtrip flight between the city pair;
calculating a total city pair number of seats using the number of seats available for each roundtrip flight between the city pair;
estimating the route fare using the total city pair flight revenue and the total city pair number of seats.

11. The method of claim 2, wherein the step of calculating a multi-route average seat mile fare over all the airline routes of the index route set comprises:
computing a multi-route total seat mile fare using the average seat mile fare for each city pair airline route of the index route set;
computing the multi-route average seat mile fare using the multi-route total seat mile fare and N, where N is the number of city pair airline routes in the index route set.

12. The method of claim 1, wherein the step of calculating an average seat mile fare comprises the following step for each city pair airline route of the index route set:
dividing the route fare by the route distance.

13. The method of claim 1, wherein the step of calculating a multi-route average seat mile fare over all the airline routes of the index route set comprises:
computing a weighted average of the average seat mile fare for each city pair airline route of the index route set;
computing the multi-route average seat mile fare using the weighted average of the average seat mile fare.

14. The method of claim 1, wherein the step of calculating a multi-route average seat mile fare over all the airline routes of the index route set comprises:
determining a daily number of flights for each airline route of the index route set;
calculating a total miles flown for each airline route using the daily number of flights for the airline route and the route distance for the airline route;
computing a total per seat revenue for each airline route using the total miles flown for the airline route and the average seat mile fare for the airline route;
computing a multi-route per seat revenue using the total per seat revenue for each airline route;
computing a multi-route total miles flown using the total miles flown for each airline route;
computing the multi-route average seat mile fare using the multi-route total miles flown and the multi-route total miles flown.

15. The method of claim 1, wherein the step of calculating the airline market index comprises:
determining a contract size;
calculating the airline market index using the multi-route average seat mile fare and the contract size.

16. The method of claim 1, further comprising:
calculating an M day moving average of the airline market index.

17. A system for computing an airline market index, the system comprising:
a selection component that selects an index route set, the index route set comprising a set of airline routes;
a distance component that determines a route distance for each airline route of the index route set;
a fare component that calculates a route fare for each airline route of the index route set;
an index component that calculates an average seat mile fare for each airline route of the index route set, and then calculates a multi-route average seat mile fare over all the airline routes of the index route set; and then calculates the airline market index using the multi-route average seat mile fare.

18. The system of claim 17, wherein the selection component comprises:
an interface for receiving passenger volume data for a plurality of city pairs having airline routes therebetween; and
a processor that selects the index route set by selecting the N city pairs of the plurality of city pairs with the largest passenger volumes, N being selected to protect against price manipulation of the airline market index.

19. The system of claim 18, wherein the fare component comprises:
an interface for receiving a predetermined set of conditions for the route fare;
a fare retriever that obtains a published fare for the city pair airline route under the predetermined set of conditions;
a processor that estimates the route fare for the city pair airline route using the published fare.

20. The system of claim 18, wherein the fare component comprises:
an interface for receiving historical data of actual airline results;
a fare mix calculator that determines a fare mix reflecting actual historical airline results, the fare mix including at least two fare classes;
a fare estimator that estimates a class fare for each fare class and that calculates the route fare using the fare mix and the class fare for each fare class.

21. The system of claim 18, wherein the index component calculates the multi-route average seat mile fare over all the airline routes of the index route set using a weighted average of the average seat mile fare for each airline route of the index route set.

22. The system of claim 18, wherein the index component further calculates an M day moving average of the airline market index.

23. An airline market index trading system comprising:
an airline market index having a current index price calculated to reflect fluctuations in the actual airline market;
airline market index contracts, each airline market index contract having a contract price and a contract delivery date;
a daily closing time for the airline market index at which time each day a daily closing price is set for the airline market index;
a clearing house that enables opening and closing of an airline market index contract by creating a buy position for the airline market index contract and a corresponding sell position for the airline market index contract.

24. The airline market index trading system of claim 23, wherein a holder of the buy position on the delivery date for the airline market index contract at the daily closing time must pay the closing price on the delivery date for the airline market index contract, and a holder of the sell position on the delivery date for the airline market index contract at the daily closing time must take the closing price on the delivery date for the airline market index contract.

25. The airline market index trading system of claim 23, further comprising mini-contracts where a certain number of mini-contracts equal one airline market index contract.

26. The airline market index trading system of claim 23, further comprising an options trading market enabling buying and selling of call options and put options, each call option and each put option having an option price and an option expiration date.
